(19) United States
(12) Patent Application Publication
(10) Pub. No.: US 2026/0358874 A1
(43) Pub. Date: Nov. 12, 2026

(54) SYSTEMS AND METHODS FOR MONITORING OVERHEATING IN COMPUTING SERVERS USING THERMOELECTRIC TEMPERATURE SENSORS

(71) Applicant: Aivres Systems Inc., San Jose, CA (US)

(72) Inventor: Chih-Jen Cheng, New Taipei City (TW)

(21) Appl. No.: 19/203,539

(22) Filed: May 9, 2025

(51) Int. Cl. G06F 1/3234; G01K 3/00; G01K 7/02; G01K 7/04

(52) U.S. Cl. CPC G06F 1/3234; G01K 3/005; G01K 7/021; G01K 7/04

(57) ABSTRACT

A system for monitoring overheating in a computing server includes a thermoelectric temperature sensor disposed proximate to an electronic component disposed on a printed circuit board (PCB) of the computing server. The thermoelectric temperature sensor is configured to produce a first signal indicative a temperature proximate to the electronic component. The system further includes an amplifier configured to amplify the first signal to produce a second signal, and a comparator configured to compare the second signal to a reference signal and produce an output. The output includes a third signal in response to the second signal exceeding the reference signal. The system further includes a processor configured to receive the output of the comparator, and in response to the output including the third signal, cause a decrease in temperature proximate to the electronic component and/or issue an alert.

### TECHNICAL FIELD

Embodiments of the present disclosure relate to electronic systems, in particular, to monitoring overheating in computing systems.

### BACKGROUND

Information technology has infiltrated almost all areas of society. People increasingly communicate using electronic devices using networks, e.g., the Internet, for work, entertainment, personal communications and the like. Thus, the amount of network data is also increasing. In order to meet the growing demand for information services, the demand for computing systems, including servers, is also increasing. The stability and performance requirements of such computing systems is also increasing. Further, space occupied by computing systems, e.g. such as servers in data centers, cannot be expanded indefinitely and are bound to be limited. In order to process more information in a limited space, solutions such as multi-node servers have been deployed. For example, a structure designed to store only one server, can implement multiple servers. In a limited space occupied by such systems, temperature is an important consideration including protection from over temperature conditions.

### SUMMARY

In a first aspect, embodiments of the present disclosure provide a system for monitoring overheating in a computing server. The system includes a thermoelectric temperature sensor disposed proximate to an electronic component disposed on a printed circuit board (PCB) of the computing server. The thermoelectric temperature sensor is configured to produce a first signal indicative a temperature proximate to the electronic component. The system further includes an amplifier configured to amplify the first signal to produce a second signal, and a comparator configured to compare the second signal to a reference signal and produce an output. The output includes a third signal in response to the second signal exceeding the reference signal. The system further includes a processor configured to receive the output of the comparator, and in response to the output including the third signal, cause a decrease in temperature proximate to the electronic component and/or issue an alert.

In a second aspect, embodiments of the present disclosure provide the system according to the first aspect, wherein the electronic component includes one or more electronic fuse (eFuse) elements.

In a third aspect, embodiments of the present disclosure provide the system according to the first aspect, wherein the electronic component includes a plurality of electronic fuse (eFuse) elements connected in parallel to each other.

In a fourth aspect, embodiments of the present disclosure provide the system according to the first aspect, wherein the thermoelectric temperature sensor includes two different metals in contact with each other.

In a fifth aspect, embodiments of the present disclosure provide the system according to the first aspect, wherein the amplifier includes an operational amplifier.

In a sixth aspect, embodiments of the present disclosure provide the system according to the fifth aspect, wherein the operational amplifier includes a negative feedback loop. The negative feedback loop includes a first resistor and a second resistor with a first resistance R₁ and a second resistance R₂, respectively.

In a seventh aspect, embodiments of the present disclosure provide the system according to the sixth aspect, wherein the first signal is a first voltage, and the operational amplifier is configured to amplify the first voltage by an amplification factor Aᵥ expressed as

$${A}_{ν} = 1 + \frac{{R}_{2}}{{R}_{1}} .$$

In an eighth aspect, embodiments of the present disclosure provide the system according to the first aspect, wherein the comparator includes an operational amplifier. The second signal is a second voltage that is input to a non-inverting input of the operational amplifier. The reference signal is a reference voltage that is input to an inverting input of the operational amplifier.

In a ninth aspect, embodiments of the present disclosure provide the system according to the first aspect, wherein the processor is configured to shut down the electronic component in response to the output of the comparator including the third signal.

In a tenth aspect, embodiments of the present disclosure provide a method of monitoring overheating in a computing server. The method includes providing a thermoelectric temperature sensor disposed proximate to an electronic component of the computing server disposed on a printed circuit board (PCB). The thermoelectric temperature sensor is configured to produce a first signal indicative a temperature proximate to the electronic component. The method further includes amplifying, using an amplifier, the first signal to produce a second signal, comparing, using a comparator, the second signal to a reference signal, and generate an output. The output includes a third signal in response to the second signal exceeding the reference signal. The method further includes, in response to the output including the third signal, causing a decrease in temperature proximate to the electronic component and/or issue an alert.

In an eleventh aspect, embodiments of the present disclosure provide the method according to the tenth aspect, wherein the electronic component includes one or more electronic fuse (eFuse) elements.

In a twelfth aspect, embodiments of the present disclosure provide the method according to the tenth aspect, wherein the electronic component includes a plurality of electronic fuse (eFuse) elements connected in parallel to each other.

In a thirteenth aspect, embodiments of the present disclosure provide a computing server. The computer server includes a processor, at least one electronic component disposed on a printed circuit board (PCB), and a thermoelectric temperature sensor disposed proximate to the at least one electronic component. The thermoelectric temperature sensor is configured to produce a first signal indicative a temperature proximate to the at least one electronic component. The computer server further includes an amplifier configured to amplify the first signal to produce a second signal, and a comparator configured to compare the second signal to a reference signal and produce an output. The output includes a third signal in response to the second signal exceeding the reference signal. The processor is configured to receive the output of the comparator, and in response to the output including the third signal, cause a decrease in temperature proximate to the at least one electronic component and/or issue an alert.

In a fourteenth aspect, embodiments of the present disclosure provide the computing server according to the thirteenth aspect, wherein the at least one electronic component includes an electronic fuse (eFuse) element.

In a fifteenth aspect, embodiments of the present disclosure provide the computing server according to the thirteenth aspect, wherein the at least one electronic component includes a plurality of electronic fuse (eFuse) elements connected in parallel to each other.

In a sixteenth aspect, embodiments of the present disclosure provide the computing server according to the thirteenth aspect, wherein the thermoelectric temperature sensor includes two different metals in contact with each other.

In a seventeenth aspect, embodiments of the present disclosure provide the computing server according to the thirteenth aspect, wherein the amplifier includes an operational amplifier.

In an eighteenth aspect, embodiments of the present disclosure provide the computing server according to the thirteenth aspect, wherein the operational amplifier includes a negative feedback loop. The negative feedback loop includes a first resistor and a second resistor with a first resistance R1 and a second resistance R2, respectively. The first signal is a first voltage. The operational amplifier is configured to amplify the first voltage by an amplification factor Aᵥ expressed as

$${A}_{ν} = 1 + \frac{{R}_{2}}{{R}_{1}} .$$

In a nineteenth aspect, embodiments of the present disclosure provide the computing server according to the thirteenth aspect, wherein the comparator includes an operational amplifier. The second signal is a second voltage that is input to a non-inverting input of the operational amplifier. The reference signal is a reference voltage that is input to an inverting input of the operational amplifier.

In a twentieth aspect, embodiments of the present disclosure provide the computing server according to the thirteenth aspect, wherein the processor is configured to shut down the at least one electronic component in response to the output of the comparator including the third signal.

### BRIEF DESCRIPTION OF THE DRAWINGS

FIG. 1 shows a diagram of a circuit layout according to some embodiments.

FIG. 2 shows an image of a printed circuit board (PCB) illustrating high temperature conditions according to some embodiments.

FIG. 3 illustrates an example of a temperature sensor according to some embodiments.

FIG. 4A is a schematic block diagram of a system for monitoring overheating in a computing server according to some embodiments.

FIG. 4B is a schematic block diagram of a system for monitoring overheating on a PCB proximate to an electronic fuse (eFuse) according to some embodiments.

FIG. 5 illustrates an example of an amplifier according to some embodiments.

FIG. 6 illustrates an example of a comparator connected to an amplifier according to some embodiments.

FIG. 7 is a flowchart illustrating a method of monitoring overheating in a computing server according to some embodiments.

### DETAILED DESCRIPTION

The following detailed description is exemplary in nature and is not intended to limit the disclosure or the application and uses of the described embodiments. Furthermore, there is no intention to be bound by any expressed or implied theory presented in the preceding background, summary and brief description of the drawings, or the following detailed description. Numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

In order to maintain system stability, circuit design needs to take into account the heat generated by electronic components. Some electronic components now have their own over temperature protection (OTP) mechanisms. When an electronic component overheats, the electronic component can trigger the OTP mechanism to shut down corresponding functions and stop output. However, the OTP mechanism is limited to its trigger state. In certain implementations, the stability and/or trigger point of the OTP mechanism may not be insufficient, which can lead to circuit burnout. For example, if the OTP mechanism of a power supply unit (PSU) is not triggered, the PSU may continue to operate, thereby increasing the severity of system damage.

According to embodiments described herein, when an electronic component in the entire system overheats but the OTP mechanism has not yet been triggered, the system can detect abnormally high temperatures in the path in advance. Therefore, the system can shut down the power supply or generate an alarm and notify the user to prevent circuit abnormalities or burning.

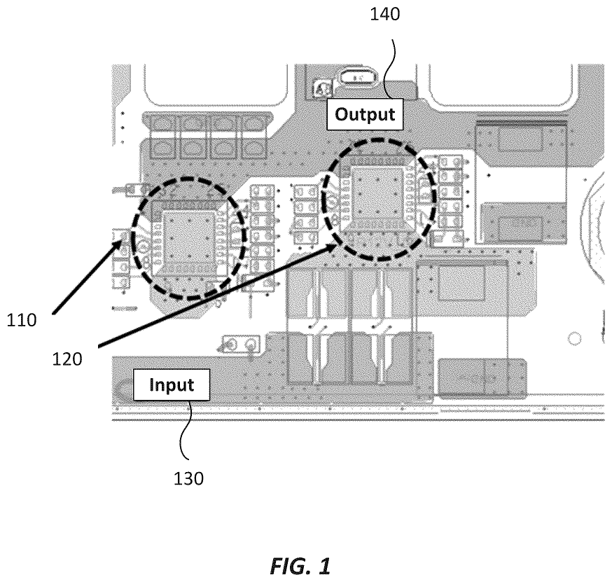

For example, an electronic fuse (referred to as eFuse) element in a circuit can be prone to overheating. An eFuse is a protective element that in certain embodiments may be built into a computer chip. It can protect the system from overvoltage, short circuit, inrush current, reverse polarity, and the like. FIG. 1 shows a schematic diagram of a circuit layout according to some embodiments. The circuit includes two eFuse elements 110 and 120 connected in parallel, between an input 130 and an output 140. Such designs are in certain implementations used for high current applications. Therefore, temperature control is very important. It will be appreciated that while embodiments are described in connection with an eFuse element, the embodiments can be implemented with other types of electronic components.

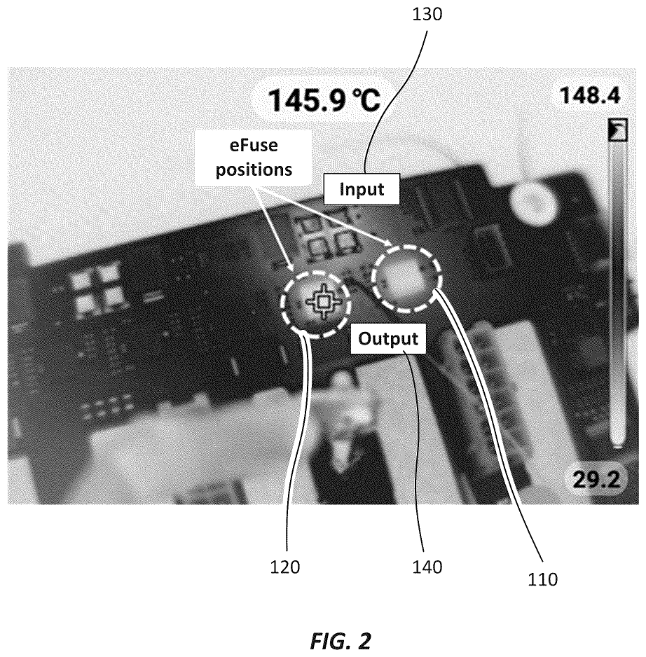

FIG. 2 shows areas of heat generation in a circuit that includes one or more eFuses. The red color (shown as darker regions in the black-and-white image) represents higher temperatures, and the green and blue colors (shown as lighter colors in the black-and-white image) represent lower temperatures. It can be seen that, as a current passes through the circuit, the images of the two eFuse elements 110 and 120 are closer to the red color, indicating higher temperatures. It can also be seen that the temperature of the area of the PCB proximate to the two eFuse elements 110 and 120 also rises. The closer to the eFuse elements, the higher the temperatures. Each eFuse element 110 or 120 may have its own OTP. If the temperature rises above an OTP trigger temperature, the circuit shuts down thereby stopping output and/or otherwise decreasing the temperature. As noted above, the OTP mechanism of certain components may not be very stable. As a result, by the time OTP is triggered, electronic components may already be damaged.

To prevent electronic components (e.g., an eFuse element) from being damaged, embodiments of the present disclosure provide systems and methods to monitor the temperature in the area proximate (e.g., areas of expected temperature rise) to the eFuse elements 110 and 120. Such configurations enable early detection of overheating thereby avoiding damage to electronic components and circuits.

According to some embodiments, a thermoelectric temperature sensor and associated circuitry are provided proximate to the eFuse elements. The thermoelectric temperature sensor produces an output voltage that is proportional to the temperature. The output voltage can be amplified and then be compared with a reference voltage or other reference signal. If the voltage is equal to or exceeds the reference voltage, a signal can be sent to a processor. The processor can shut down the circuit or issue an alarm before the OTP is triggered, thereby preventing the eFuse elements and other electronic components from being damaged.

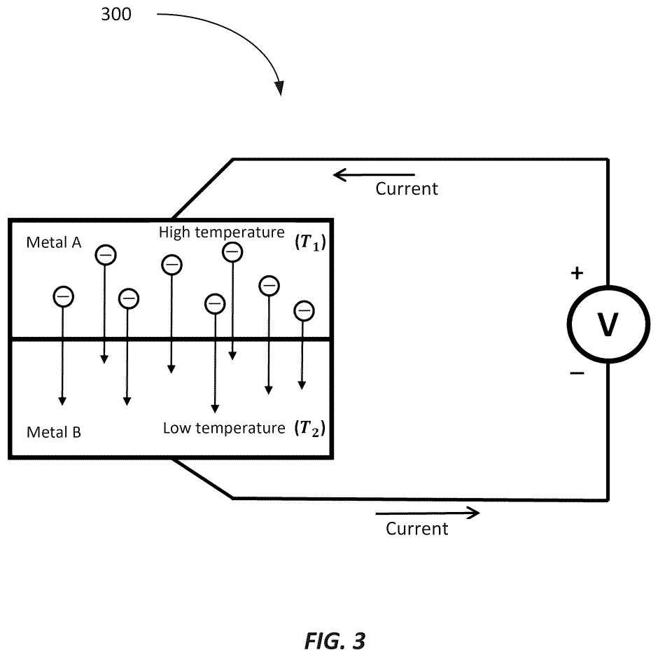

FIG. 3 illustrates an example of a thermoelectric temperature sensor 300. The thermoelectric temperature sensor 300 includes two different metals A and B in contact with each other. Metal A is at a first temperature T₁. Metal B is at second temperature T₂, which is different from T₁ (e.g., T₁ is higher than T₂). When two different metals are in contact with each other, given a temperature difference between the two metals, there are more charge carriers (e.g., electrons) with high energy at the end with the higher temperature as compared to the end with the lower temperature, e.g., relative hot end than at the relative cold end. Therefore, high-energy charge carriers would move from the hot end towards the cold end across the contact surface in a diffusion process. The diffusion of the charge carriers can cause an electromotive force. This effect is referred to as the Seebeck effect. The charge carrier diffusion rate is proportional to the temperature difference at the contact surface. As long as the temperature difference between the two metals is maintained, the charge carrier diffusion phenomenon can be maintained to form a stable voltage. Different metals have different Seebeck coefficients. Let S_{A} and S_{B} denote the Seebeck coefficients of metal A and metal B, respectively. The voltage can be expressed as V=(S_{B}−S_{A})·(T₂−T₁).

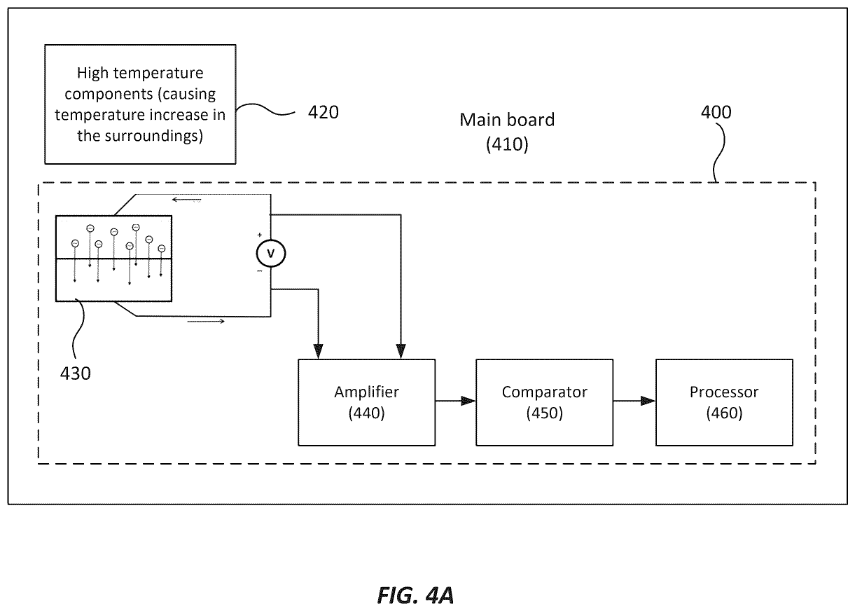

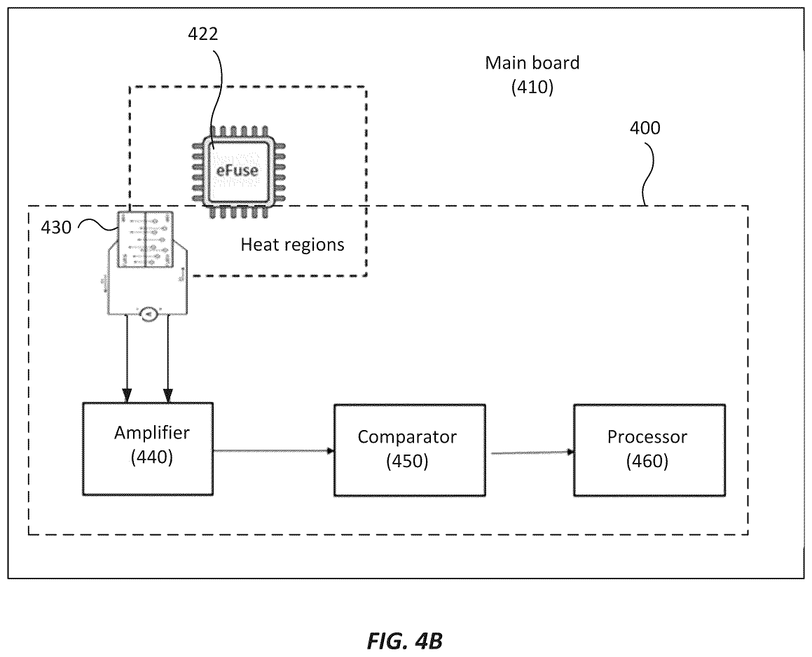

FIG. 4A is a block diagram of a system 400 for monitoring overheating in a computer server, according to some embodiments. FIG. 4B is a block diagram 400 of the system for monitoring overheating on a PCB proximate to an eFuse 422 according to some embodiments. The system 400 is, for example, disposed on a main printed circuit board (PCB) 410 of the computing server. A thermoelectric temperature sensor 430 is positioned proximate (e.g., where temperature rise is expected) to an electronic component 420 or an eFuse 422 of the computing server that tends to overheat. A first signal (e.g. a first voltage V) generated in the thermoelectric temperature sensor 430 is input to an amplifier 440. After amplification, a second signal (e.g., a second voltage) is input to a comparator 450, in which the second signal is compared to a reference signal (e.g., a reference voltage). When the second signal exceeds the reference signal, the comparator 450 outputs a third signal to a processor 460. Upon receiving the third signal, the processor 460 can determine that an abnormally high temperature in the vicinity of the electronic component 420 or the eFuse 422 has occurred. The processor 460 can initiate certain actions accordingly. For example, the processor 460 can shut down the power to the power supply unit, issue an alarm, and/or adjust conditions of the systems to reduce temperature.

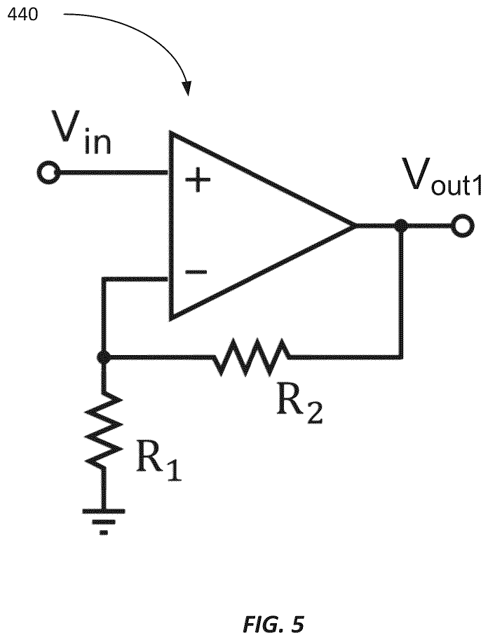

FIG. 5 illustrates an example of the amplifier 440 shown in FIG. 4, which in the embodiment shown is a non-inverting operational amplifier. The input voltage Vᵢₙ at the non-inverting input (denoted by the sign “+”) of the operational amplifier is the voltage generated by the thermoelectric temperature sensor 430. A negative feedback loop connects the output Vₒᵤₜ₁ to the inverting input (denoted by the sign “−”). The feedback loop includes two resistors R₁ and R₂. The amplification factor Aᵥ can be expressed by the formula

$${A}_{ν} = 1 + \frac{{R}_{2}}{{R}_{1}} .$$

Thus, the amplification factor can be adjusted by selecting the resistance values R₁ and R₂. The operational amplifier outputs a voltage

$${V}_{o u t 1} = {V}_{i n} \cdot {A}_{ν} = {V}_{i n} \cdot ( 1 + \frac{{R}_{2}}{{R}_{1}} ) .$$

The resistors R₁ and R₂ may be variable resistors that may be programmable and/or dynamically adjusted by the processor to alter the temperature at which Vₒᵤₜ₂ outputs a high-level output.

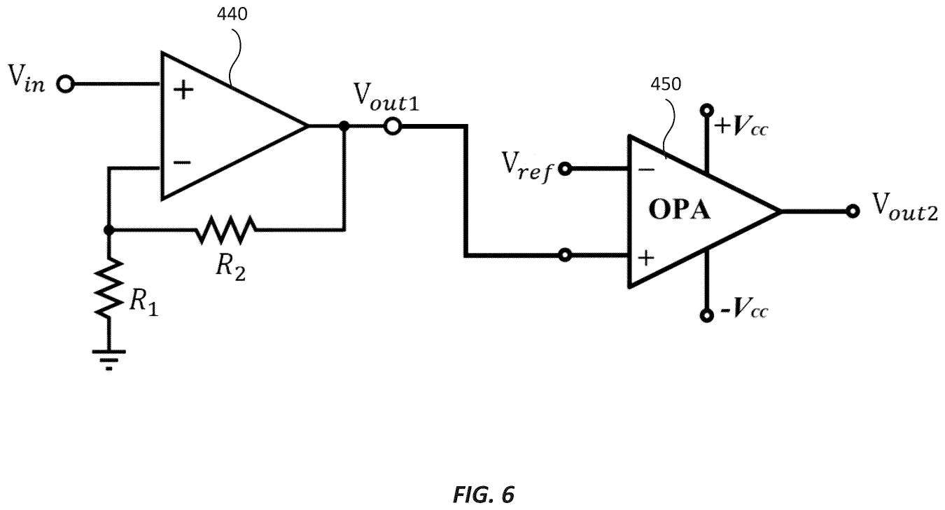

FIG. 6 illustrates an example of a comparator 450 connected to the amplifier 440 according to some embodiments. The comparator 450 can be configured as an operational amplifier. The output Vₒᵤₜ₁ of the amplifier 440 is input to the non-inverting input of the comparator 450. A reference voltage V_{ref} is input to the inverting input of the comparator 450. The output Vₒᵤₜ₂ of the comparator 450 is proportional to a difference between Vₒᵤₜ₁ and V_{ref}. V_{ref} is chosen such that under normal operation (e.g., the electronic component 420 or the eF use 422 is not overheated), Vₒᵤₜ₁ would be less than V_{ref}. In such cases, Vₒᵤₜ₂ would be a low-level signal. When the temperature in the vicinity of the electronic component 420 or the eF use 422 rises, Vᵢₙ would increase and causing Vₒᵤₜ₁ to increase proportionally. When Vₒᵤₜ₁ exceeds V_{ref}, the comparator 450 would output a high-level signal at Vₒᵤₜ₂. The high-level signal is input into the processor 460. After receiving the high-level signal, the processor 460 can force the system to stop running, issue an alert alter system operation, so as to protect the system.

In certain implementations, V_{ref} may be programmable and/or dynamically adjusted by the processor to account for varying conditions within the computing server.

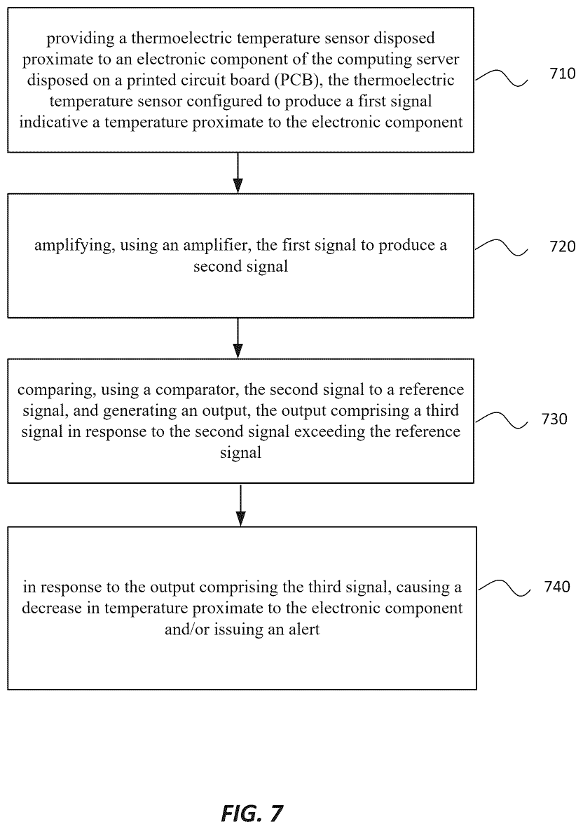

FIG. 7 is a flowchart illustrating a method of monitoring overheating on a PCB of a computing server according to some embodiments. The method includes, at 710, providing a thermoelectric temperature sensor disposed proximate to an electronic component of the computing server disposed on the PCB. The thermoelectric temperature sensor is configured to produce a first signal indicative a temperature proximate to the electronic component. The method further includes, at 720, amplifying, using an amplifier, the first signal to produce a second signal. The method further includes, at 730, comparing, using a comparator, the second signal to a reference signal, and generating an output. The output includes a third signal in response to the second signal exceeding the reference signal. The method further includes, at 740, in response to the output including the third signal, causing a decrease in temperature proximate to the electronic component and/or issuing an alert.

As described above, although certain components may have their own OTP mechanisms, the stability of the OTP mechanisms may be insufficient, which can lead to circuit burnout. If the OTP mechanism is not triggered, the system can continue to operate, thereby increasing the severity of system damage. Embodiments of the present disclosure uses a thermoelectric sensor positioned in the vicinity of the eFuse elements. The thermoelectric sensor generates a voltage that is proportional to the temperature. When the temperature in the vicinity of the eFuse rises abnormally, the voltage will also rise. The voltage is then amplified by an amplifier and compared to a reference voltage by a comparator. The comparator generates a signal when the voltage exceeds the reference voltage. The signal is passed to the system chip to achieve a protection effect.

The use of the terms “a” and “an” and “the” and “at least one” and similar referents in the context of describing the embodiments (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the embodiments unless otherwise claimed. No language in the specification should be construed as indicating any non-claimed element as essential to the practice of the invention.

Preferred embodiments are described herein. Variations of those preferred embodiments may become apparent to those of ordinary skill in the art upon reading the foregoing description. The inventors expect skilled artisans to employ such variations as appropriate, and the inventors intend for the embodiments herein to be practiced otherwise than as specifically described. Accordingly, embodiments includes all modifications and equivalents of the subject matter recited in the claims appended hereto as permitted by applicable law. Moreover, any combination of the above-described elements in all possible variations thereof is encompassed by the embodiments unless otherwise indicated herein or otherwise clearly contradicted by context.

1. A system for monitoring overheating in a computing server, the system comprising:
a thermoelectric temperature sensor disposed proximate to an electronic component disposed on a printed circuit board (PCB) of the computing server, the thermoelectric temperature sensor configured to produce a first signal indicative a temperature proximate to the electronic component;
an amplifier configured to amplify the first signal to produce a second signal;
a comparator configured to compare the second signal to a reference signal and produce an output, the output comprising a third signal in response to the second signal exceeding the reference signal; and
a processor configured to receive the output of the comparator, and in response to the output comprising the third signal, cause a decrease in temperature proximate to the electronic component and/or issue an alert.

2. The system of claim 1, wherein the electronic component comprises one or more electronic fuse (eFuse) elements.

3. The system of claim 1, wherein the electronic component comprises a plurality of electronic fuse (eFuse) elements connected in parallel to each other.

4. The system of claim 1, wherein the thermoelectric temperature sensor comprises two different metals in contact with each other.

5. The system of claim 1, wherein the amplifier comprises an operational amplifier.

6. The system of claim 5, wherein the operational amplifier comprises a negative feedback loop, the negative feedback loop comprising a first resistor and a second resistor with a first resistance R₁ and a second resistance R₂, respectively.

7. The system of claim 6, wherein the first signal is a first voltage, and the operational amplifier is configured to amplify the first voltage by an amplification factor Aᵥ expressed as
$${A}_{ν} = 1 + \frac{{R}_{2}}{{R}_{1}} .$$

8. The system of claim 1, wherein the comparator comprises an operational amplifier, and wherein the second signal is a second voltage that is input to a non-inverting input of the operational amplifier, and the reference signal is a reference voltage that is input to an inverting input of the operational amplifier.

9. The system of claim 1, wherein the processor is configured to shut down the electronic component in response to the output of the comparator comprising the third signal.

10. A method of monitoring overheating in a computing server, the method comprising:
providing a thermoelectric temperature sensor disposed proximate to an electronic component of the computing server disposed on a printed circuit board (PCB), the thermoelectric temperature sensor configured to produce a first signal indicative a temperature proximate to the electronic component;
amplifying, using an amplifier, the first signal to produce a second signal;
comparing, using a comparator, the second signal to a reference signal, and generating an output, the output comprising a third signal in response to the second signal exceeding the reference signal; and
in response to the output comprising the third signal, causing a decrease in temperature proximate to the electronic component and/or issuing an alert.

11. The method of claim 10, wherein the electronic component comprises one or more electronic fuse (eFuse) elements.

12. The method of claim 10, wherein the electronic component comprises a plurality of electronic fuse (eFuse) elements connected in parallel to each other.

13. A computing server comprising:
a processor;
at least one electronic component disposed on a printed circuit board (PCB);
a thermoelectric temperature sensor disposed proximate to the at least one electronic component, the thermoelectric temperature sensor configured to produce a first signal indicative a temperature proximate to the at least one electronic component;
an amplifier configured to amplify the first signal to produce a second signal; and
a comparator configured to compare the second signal to a reference signal and produce an output, the output comprising a third signal in response to the second signal exceeding the reference signal;
wherein the processor is configured to receive the output of the comparator, and in response to the output comprising the third signal, cause a decrease in temperature proximate to the at least one electronic component and/or issue an alert.

14. The computing server of claim 13, wherein the at least one electronic component comprises an electronic fuse (eFuse) element.

15. The computing server of claim 13, wherein the at least one electronic component comprises a plurality of electronic fuse (eFuse) elements connected in parallel to each other.

16. The computing server of claim 13, wherein the thermoelectric temperature sensor comprises two different metals in contact with each other.

17. The computing server of claim 13, wherein the amplifier comprises an operational amplifier.

18. The computing server of claim 17, wherein the operational amplifier comprises a negative feedback loop, the negative feedback loop comprising a first resistor and a second resistor with a first resistance R₁ and a second resistance R₂, respectively, and wherein the first signal is a first voltage, and the operational amplifier is configured to amplify the first voltage by an amplification factor Aᵥ expressed as
$${A}_{ν} = 1 + \frac{{R}_{2}}{{R}_{1}} .$$

19. The computing server of claim 13, wherein the comparator comprises an operational amplifier, and wherein the second signal is a second voltage that is input to a non-inverting input of the operational amplifier, and the reference signal is a reference voltage that is input to an inverting input of the operational amplifier.

20. The computing server of claim 13, wherein the processor is configured to shut down the at least one electronic component in response to the output of the comparator comprising the third signal.
